(19) United States
(12) Patent Application Publication
(10) Pub. No.: US 2008/0225967 A1
(43) Pub. Date: Sep. 18, 2008

(54) METHOD AND APPARATUS FOR MIMO CHANNEL ESTIMATION USING TDS-OFDM IN DOWNLINK TRANSMISSION IN THE TIME DOMAIN

(75) Inventors: LIN YANG, FREMONT, CA (US); QIN LIU, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/048,261

(22) Filed: Mar. 14, 2008

Related U.S. Application Data
(60) Provisional application No. 60/895,113, filed on Mar. 15, 2007.

(51) Int. Cl. H04L 27/28

(52) U.S. Cl. 375/260

(57) ABSTRACT

In an orthogonal frequency division multiplexing (OFDM) multiple-input multiple-output (MIMO) wireless communication system, a method is provided. In the OFDM MIMO wireless communication system, both a transmitter and a receiver include a plurality of antennas. The method comprising the step of: a receiver using at least one pseudo noise (PN) to correlate desired information relating to a received symbol; and performing channel estimation using the correlated information.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-035.

U.S. patent application Ser. No. ______ with attorney docket number LSFFT-036.

U.S. patent application Ser. No. ______ with attorney docket number LSFFT-037.

U.S. patent application Ser. No. ______ with attorney docket number LSFFT-038.

U.S. patent application Ser. No. ______ with attorney docket number LSFFT-039.

U.S. patent application Ser. No. ______ with attorney docket number LSFFT-040.

U.S. patent application Ser. No. ______ with attorney docket number LSFFT-041.

### REFERENCE TO RELATED APPLICATIONS

This application claims an invention which was disclosed in Provisional Application No. 60/895,113, filed Mar. 15, 2006 entitled “METHOD AND APPARATUS FOR MIMO CHANNEL ESTIMATION USING TDS-OFDM IN DOWNLINK TRANSMISSION IN THE TIME DOMAIN”. The benefit under 35 USC §119(e) of the U.S. provisional application is hereby claimed, and the aforementioned application is hereby incorporated herein by reference.

### FIELD OF THE INVENTION

The present invention relates generally to MIMO (multiple-in, multiple-out) applications relating to such communications systems as TDS-OFDM (time domain synchronous orthogonal frequency division multiplex) system, more specifically the present invention relates to MIMO channel estimation in the time domain for TDS-OFDM system in information transmission associated with in downlink transmission within the time domain.

### BACKGROUND

TDS-OFDM was successfully applied to digital TV applications such as DMB-TH. Typically, in DTV (digital television) applications, a SISO (single-in single-out) scheme or system are constructed. However, there is no solution for the application of MIMO to TDS-OFDM systems.

Therefore, it is desirous to provide a solution for the application of MIMO to TDS-OFDM systems. More specifically, to provide channel estimation in the time domain of a MIMO TDS-OFDM system.

### SUMMARY OF THE INVENTION

A method and system is provided for channel estimation in the time domain of a MIMO TDS-OFDM system.

In an orthogonal frequency division multiplexing (OFDM) multiple-input multiple-output (MIMO) wireless communication system, a method is provided. In the OFDM MIMO wireless communication system, both a transmitter and a receiver include a plurality of antennas. The method comprising the step of: a receiver using at least one pseudo noise (PN) sequence to correlate desired information relating to a received symbol; and performing channel estimation using the correlated information.

In an orthogonal frequency division multiplexing (OFDM) with devices intercommunicating wirelessly, each device has multiple-input multiple-output (MIMO) means including a plurality of antennas. A method comprising the steps of: a receiver using at least one pseudo noise (PN) to correlate desired information relating to a received symbol; and performing channel estimation using the correlated information.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a MIMO TDS-OFDM system in accordance with some embodiments of the invention.

FIG. 2 is an example of a symbol composition in accordance with some embodiments of the invention.

FIG. 3 is an example of a correlating device or matched filter for a TDS-OFDM MIMO receiver in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to channel estimation in the time domain of a MIMO TDS-OFDM system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of channel estimation in the time domain of a MIMO TDS-OFDM system described herein. The non-processor circuits may include, but are not limited to, a radio receiver, a radio transmitter, signal drivers, clock circuits, power source circuits, and user input devices. As such, these functions may be interpreted as steps of a method to perform channel estimation in the time domain of a MIMO TDS-OFDM system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

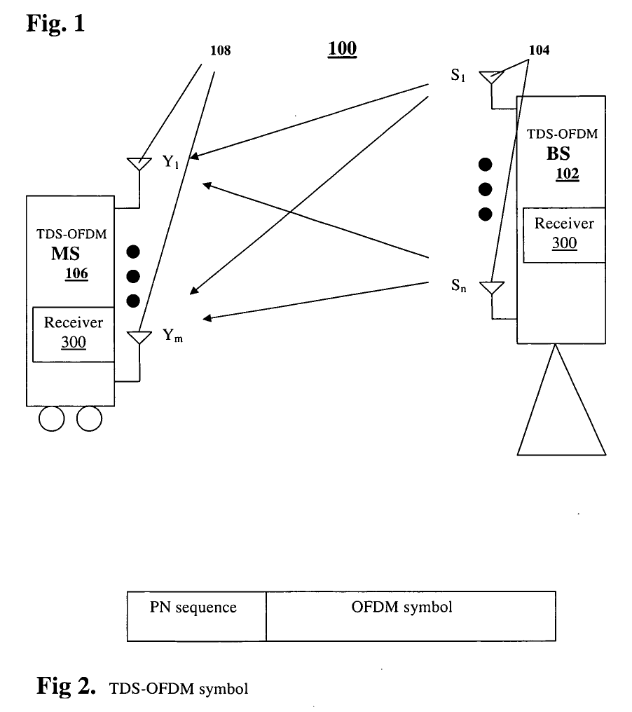

Referring to FIGS. 1-3, a plurality of base stations (BS) 102 (only one shown) each has two or more BS antennas 104. Each one of the antennas 104 respectively transmits signals S₁, S₂, . . . , Sₙ. At least one of the signals Sᵢ among the transmitted signals S₁, S₂, . . . , Sₙ uses the format shown in FIG. 2 employing a pseudo noise (PN) sequence Pᵢ as guard interval that may be among a plurality of PN acting as guard intervals interposed or inserted between data or symbols such as OFDM symbols. Mobile station (MS) 106 receives signals using multiple MS antennas 108. Each one of the antennas 108 is adapted to receive from all transmitted signals including the transmitted signals S₁, S₂, . . . , Sₙ from BS 102 as well as other base stations (not shown). Mobile station 106 comprises a receiver 300 for receiving signals from surrounding base stations. The receiver 300 in mobile station 106 is adapted such that all the PN sequences of substantially all the transmitted signals from substantially all the base stations including BS 102 in a predetermined neighborhood or geographic area are known to the base station 106. In other words, BS 102 and MS 106 know the PN sequences within a wireless communication neighborhood. This is advantageous in a TDS-OFDM system in that the guard intervals are the PN sequences. The receiver 300 is adapted to use the PN codes to perform a correlation in order to find a timing of each path. Both base station 102 and mobile station 106 comprise receivers 300.

Referring specifically to FIG. 2, a packet of transmission or a received packet having PN sequence as guard interval among a plurality of guard intervals (only one shown) is shown. The packet is positioned sequentially within a frame among a multiplicity of packets. As can be appreciated, PNs are disposed between the OFDM symbols. It is noted that the present invention contemplates using the PN sequence disclosed in U.S. Pat. No. 7,072,289 to Yang et al which is hereby incorporated herein by reference.

It is advantageous over other systems in the use of PNs as guard intervals between symbols or data in such systems as TDS-OFDM systems. The advantages include improved channel estimation time, improved synchronization time, and less need to insert more known values such as pilots in what would be used or reserved for data.

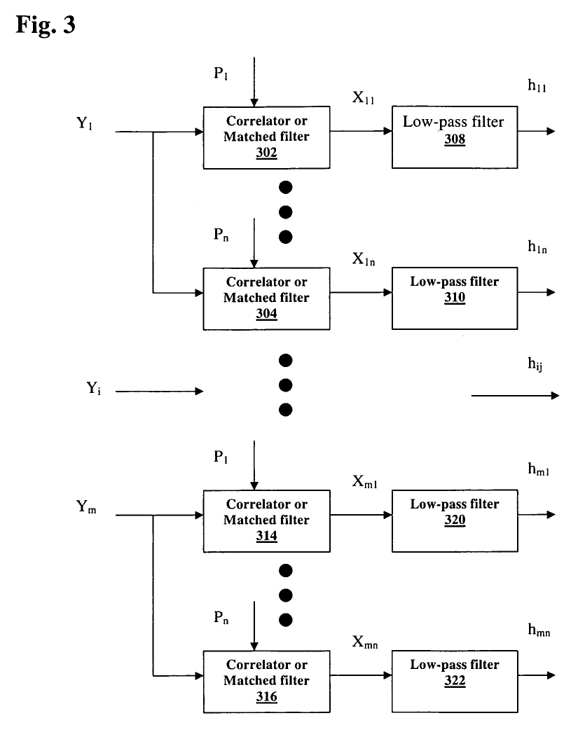

Referring specifically to FIG. 3, a correlator using a corresponding PN sequence such as a PN sequence known to receiver 300 is used to extract the desired information based on the known PN sequence. By way of example, Y₁ comprises information received from transmitted signals S₁, S₂, . . . , Sₙ associated with base station 102, and other bases stations (not shown) as well. For the sake of simplicity only a single base station is shown herein FIG. 1. Using an associated PN, P₁ for correlation with Y₁, correlated information X₁₁ is obtained. Correlated information X₁₁ may be obtained by such devices as a matched filter 302. The filtered information X₁₁ is further subjected to a low pass filter 308. Similarly, for other associated PN such as Pₙ, X₁ₙ is obtained by such devices as a matched filter 304. The filtered information X₁ₙ is further subjected a low pass filter 310.

By way of a second example, Yₘ comprises information received from transmitted signals S₁, S₂, . . . , Sₙ associated with base station 102, and other bases stations (not shown) as well. For the sake of simplicity only a single base station is shown. Using an associated PN herein denoted as P₁, Xₘ₁ is obtained by such devices as a matched filter 314. The filtered information Xₘ₁ is further subjected a low pass filter 320. Similarly, by using an associated PN herein referred to as Pₙ, Xₘₙ is obtained by such devices as a matched filter 316. The filtered information Xₘₙ may further subjected a low pass filter 322. Further, for each correction channel elements hᵢⱼ where i ranges from 1 to m, and j ranges from 1 to n are obtained for further processing.

As can be seen, the outputs Xᵢⱼ are used directly for channel estimations. Alternatively, the filtered Xᵢⱼ, i.e. hᵢⱼ may be a better candidate for channel estimations. Either way, channel estimations are performed in the time-domain by directly correlating or match filtering with reference signals such as PN sequences. In the case of TDS-OFDM, the use of known PN sequences acting as guard intervals is involved.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In an orthogonal frequency division multiplexing (OFDM) with devices intercommunicating wirelessly, each device having multiple-input multiple-output (MIMO) means including a plurality of antennas, a method comprising the steps of:
providing a receiver using at least one pseudo noise (PN) to correlate desired information relating to a received symbol; and
performing channel estimation using the correlated information.

2. The method of claim 1, wherein the step of performing channel estimation comprises using a matched filter associated with the received symbol.

3. The method of claim 1, wherein the step of performing channel estimation comprises using a low-pass filter associated with the received symbol.

4. The method of claim 1, wherein the OFDM system comprises a TDS-OFDM system.

5. The method of claim 1, wherein the PN sequence is used as a guard interval between transmitted symbols.

6. The method of claim 1, wherein a matched filer is used to correlate the desired information relating to the received symbol.

7. In an orthogonal frequency division multiplexing (OFDM) with devices intercommunicating wirelessly, each device having multiple-input multiple-output (MIMO) means including a plurality of antennas, a receiver comprising:
means for receiving at least one pseudo noise (PN) to correlate desired information relating to a received symbol; and
means for channel estimation using the correlated information.

8. The receiver of claim 7, wherein means for channel estimation comprises a matched filter associated with the received symbol.

9. The receiver of claim 7, wherein the means for channel estimation comprises a low-pass filter associated with the received symbol.

10. The receiver of claim 7, wherein the OFDM system comprises a TDS-OFDM system.

11. The receiver of claim 7, wherein the PN sequence is used as a guard interval between transmitted symbols.

12. The receiver of claim 7, wherein a matched filer is used to correlate the desired information relating to the received symbol.
